(19) United States
(12) Patent Application Publication
(10) Pub. No.: US 2017/0364093 A1
(43) Pub. Date: Dec. 21, 2017

(54) DRONE COMPRISING LIFT-PRODUCING WINGS

(71) Applicant: PARROT DRONES, Paris (FR)

(72) Inventors: Marc Mari Mari, Paris (FR); Gauthier Lavagen, Rosny Sous-Bois (FR); Yoni Benatar, Les Lilas (FR)

(21) Appl. No.: 15/628,541

(22) Filed: Jun. 20, 2017

(30) Foreign Application Priority Data
Jun. 20, 2016 (FR) 1655742

(51) Int. Cl. G05D 1/08; G05D 1/02; B64C 13/16; B64C 27/26

(52) U.S. Cl. CPC G05D 1/0825; B64C 27/26; G05D 1/0202; G05D 1/0858; G05D 1/085; B64C 13/16; B64C 2201/088; B64C 2201/104; B64C 2201/108; G05D 1/0808; B64C 2201/165

(57) ABSTRACT

A method for dynamically controlling the attitude of a rotary-wing drone. The method includes dynamically controlling the attitude of the drone when the drone is flying using lift of each of four wings of the drone, by controlling the attitude of the drone by sending differentiated commands to one or more propulsion units of the drone so as to rotate the drone about a roll axis and/or pitch axis and/or heading axis of the drone from a current angular position to a final angular position, the axes being defined in the reference point of the drone.

### CROSS REFERENCE TO RELATED APPLICATIONS

This application claims priority under 35 U.S.C. §119(a) to French Patent Application Serial Number 1655742, filed Jun. 20, 2016, the entire teachings of which are incorporated herein by reference.

### BACKGROUND OF THE INVENTION

### Field of the Invention

The invention relates to leisure drones, in particular rotary-wing drones such as quadcopters and similar.

### Description of the Related Art

Flying drones include a drone body and propulsion units mounted at the end of link arms, each propulsion unit being provided with a propeller driven by an individual motor. The different motors can be controlled in a differentiated manner in order to control the attitude and speed of the drone.

An example is the Rolling Spider™ marketed by Parrot Drones SAS, Paris, France.

Quadcopters are provided with four propulsion units each equipped with a propeller. The propellers on two propulsion units rotate in the clockwise direction and the propellers on the other two propulsion units rotate in the anti-clockwise direction. The propulsion units equipped with propellers rotating in the same direction of rotation are positioned on the same diagonal line. Each propeller exerts traction on the drone owing to the lift of the propeller, this traction being directed upwards, and a torque which is in the opposite direction to the direction of rotation of said propeller.

Published Patent Cooperation Treaty Application WO 2010/061099 A2, and European Patent Application Publications EP 2 364 757 A1 and EP 2 450 862 A1 each describe the principle of piloting a drone by means of a multimedia telephone or tablet having a touch screen and integrated accelerometers, for example a smartphone or a tablet computer.

There are four commands issued by the piloting device, namely roll, i.e. the rotational movement about its longitudinal axis, pitch, i.e. the rotational movement about the transverse axis, yaw, also known as heading, i.e. the direction in which the drone is oriented, and vertical acceleration.

When a yaw command is sent to the drone, the propulsion units that have propellers rotating in one direction rotate faster, i.e. the propulsion units accelerate, whereas the other two propulsion units rotate less quickly.

In this way, the sum of the lift forces compensates for the weight of the drone, but the sum of the torques is no longer zero and the drone therefore turns onto a yaw. Turning the drone to the right or the left onto a yaw depends on the two diagonal propulsion units that are required to accelerate their rotation.

When a pitch command is sent to the drone, the propulsion units situated in the direction of the drone are slowed down and the propulsion units situated to the rear relative to the direction of movement of the drone are accelerated.

When a roll command is sent to the drone, the propulsion units situated in the desired direction of rotation of the drone are slowed down and the propulsion units situated on the opposite side are accelerated.

However, this type of drone is limited in its application, as it only allows quadcopter flight, i.e. using rotary wings.

In the field of scale models, a number of aircraft-type flying devices are known which do not allow flight by lift and rotary-wing propulsion, but flight assured by a thruster and for which lift is provided by the lift-producing wings of said aircraft. The aircraft are therefore considered fixed-wing apparatuses. Scale aircraft-type models have ailerons which are aerodynamic control surfaces moving in the opposite direction and being used to produce a roll torque in particular, a rudder which makes rotation about the heading axis possible, and an elevator allowing the aircraft to effect a pitch rotation.

However, it is noted that said scale models are difficult to pilot and are often subject to crashes that damage the scale model.

### BRIEF SUMMARY OF THE INVENTION

The object of the invention is to propose a rotary-wing drone that allows a drone of this kind to fly not only using the lift of the rotational surfaces, namely the rotary wings, but also to fly like an aircraft using a fixed wing, while benefiting from the easy control offered nowadays by drones.

Accordingly, the invention proposes a method for dynamically controlling the attitude of a rotary-wing drone comprising a drone body that comprises an electronic board which controls the piloting of the drone, and four link arms, each arm comprising a rigidly connected propulsion unit.

In a characteristic manner, the four link arms form lift-producing wings, and when the drone is flying using the lift of the four wings, the attitude of the drone is controlled by sending differentiated commands to one or more of said propulsion units so as to rotate the drone about the roll axis and/or the pitch axis and/or the heading axis of the drone from a current angular position to a final angular position, said axes being defined in the reference point of the drone.

According to various additional features, taken alone or in combination:

the attitude of the drone is controlled solely by sending said commands to one or more of said propulsion units;

the method comprises:

a step of estimating an angle of incidence α of the drone body relative to the horizontal,

a step of calculating the aerodynamic speed V of the drone,

a step of determining an angle of inclination along a roll axis φ_{c} according to the estimated angle of incidence α, the aerodynamic speed V and a given angular velocity about a yaw axis ψᵤₛᵣ, and

a step of sending one or more differentiated commands determined according to the determined angle of inclination φ_{c} to one or more of said propulsion units in order to control the attitude of said drone;

the step of sending one or more differentiated commands comprises generating roll angle set values and applying said set values to a servo-control loop of the motors of the drone;

the steps of the method are carried out periodically until said final angular position is achieved;

the angle of incidence α is determined according to the pitch angle θ of said drone body;

the angle of incidence α is determined such that:

α=|θ|−90° i)

the angle of inclination is such that:

$${ϕ}_{c} = {tan}^{- 1} \frac{cos α V {ψ}_{usr}}{g}$$

i) g being the gravitational acceleration;

the method further comprises:
a) a step of estimating the aerodynamic speed V of the displacement of the drone on the basis of a model and
b) a step of measuring the altitude of the drone,
c) a step of sending differentiated commands for the motors in order to maintain the altitude of the drone, said step comprising a closed-loop control phase of the motors;

the horizontal velocity of the drone is controlled by modifying the pitch angle.

The invention also relates to a rotary-wing drone comprising a drone body that comprises an electronic board which controls the piloting of the drone, and four link arms, each arm comprising a rigidly connected propulsion unit. In a characteristic manner, the four link arms form lift-producing wings and the drone is suitable for implementing the above-described method for dynamically controlling the attitude of said drone.

### BRIEF DESCRIPTION OF THE SEVERAL VIEWS OF THE DRAWINGS

An embodiment of the present invention will now be described with reference to the accompanying drawings.

FIG. 1 is a general view of the drone according to the invention seen from above when the drone is on the ground.

FIG. 2 is a side view of the drone according to the invention when the drone is in flight using the lift of the wings.

FIG. 3 is a view from above of the drone according to the invention when the drone is in flight using the lift of the wings.

FIG. 4 is a rear view of the drone according to the invention when the drone is in flight using the lift of the wings.

FIG. 5 is a state diagram of the attitude control of the drone according to the invention.

FIG. 6 is a block diagram of the different control and servo-control components and dynamic control components of a rotary-wing drone according to the invention.

### DETAILED DESCRIPTION OF THE INVENTION

An embodiment of the invention will now be described.

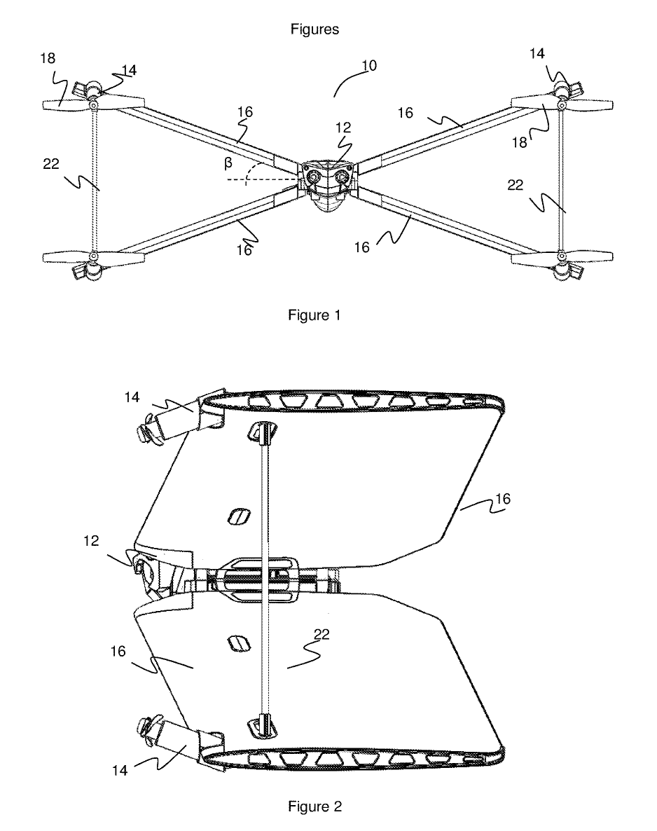

In FIG. 1, reference sign 10 generally designates a rotary-wing drone. In the example shown in FIG. 1, it is a quadcopter-type drone derived from the Rolling Spider™ model marketed by Parrot Drones SAS, Paris, France.

The quadcopter drone includes a drone body 12 and four propulsion units 14 rigidly connected to the four link arms 16, respectively. The propulsion units 14 are independently piloted by an integrated navigation and attitude control system. Each propulsion unit 14 is equipped with a propeller 18 driven by an individual motor. The different motors can be controlled in a differentiated manner in order to control the attitude and speed of the drone and with the production of positive lift.

The propellers 18 on two propulsion units rotate in the clockwise direction and the propellers on the other two propulsion units rotate in the anti-clockwise direction. The propulsion units equipped with propellers rotating in the same direction of rotation are positioned on the same diagonal line.

In a manner that is characteristic of the invention, the four link arms 16 form lift-producing wings, substantially perpendicular to the plane of the propellers, allowing the drone to fly either using the rotary wings or in so-called aircraft flight, so as to benefit from the lift of the lift-producing wings.

According to a particular embodiment, the propulsion units are secured substantially to the end of the lift-producing wings as shown in FIG. 1.

Alternatively, the propulsion units may be secured over almost the entire length of the lift-producing wings, notably in the region of the leading edge of each of the wings; however, a minimum distance between two adjacent propulsion units should be respected, and said distance should not be less than the sum of the radii of the two propellers on said adjacent propulsion units.

According to the invention, the drone comprises flight conversion means allowing the drone to effect a conversion after take-off in quadcopter mode, i.e. using the lift of the rotational surfaces, so that the drone flies using the lift of the wings.

To do this, the drone effects a conversion of a given angle, namely an angle □ of from for example 20° to 90°, and preferably an angle □ of between 20° and 80°, such that the drone benefits from the lift of the four wings in order to fly. Thus, the drone is suitable for flying conventionally using the lift of the rotational surfaces or like an aircraft using the lift of the wings. This type of drone has the advantage of being suitable for flying like an aircraft, but allows good control of the flight speed, as said drone is also suitable for flying very slowly, notably if the conversion angle is a small angle.

If the drone is defined before take-off according to the three orthogonal axes X, Y and Z, said axes will then be named:

X axis, the roll axis which is defined by the fact that a rotation of the drone on this axis allows the drone to be moved to the right or to the left, and

Y axis, the pitch axis which is defined by the fact that a rotation of the drone on this axis allows the drone to be moved forwards or backwards,

Z axis, the yaw axis or heading axis, which is defined by the fact that a rotation of the drone on this axis has the effect of making the main axis of the drone pivot to the right or to the left; thus, the direction of forward movement of the drone.

Thus, the conversion can be defined by the fact that the Z axis of the drone, corresponding to the heading axis during drone flight in conventional mode, i.e. using the lift of the rotary wing, becomes the roll axis when the drone transitions into aircraft flight mode, i.e. using the fixed wing, in other words the lift of the four wings.

The drone shown in FIG. 1 comprises four link arms in the form of lift-producing wings; however, this type of drone could comprise more than four lift-producing wings.

According to a particular embodiment, the drone body 12 has an elongate shape, for example. According to this embodiment, the lift-producing wings of the drone are secured to the entire length or to a portion of the length of the drone body.

The drone shown in FIG. 1 is such that the lift-producing wings 16 are positioned on each side of the drone body defined by the horizontal median plane of the drone body 12 when the drone is in the aircraft flight position, and the lift-producing wings are symmetric and form a dihedral, for example.

According to another embodiment, the lift-producing wings on either side of the drone body may not be symmetric relative to said horizontal median plane of the drone body.

It can also be seen that the drone shown in FIG. 1 is such that the lift-producing wings 16 are situated on each side of the drone relative to the vertical median plane 12 when the drone is in the aircraft flight position and the lift-producing wings are symmetric.

According to another embodiment, the lift-producing wings on either side of the drone body may not be symmetric relative to said vertical median plane of the drone body.

The structure of the drone as shown in FIG. 1 is X-shaped having a positive dihedral angle on the upper wings relative to the horizontal median plane of the drone body when the drone is in the aircraft flight position, and a negative dihedral angle of the same value on the lower wings relative to said horizontal median plane. However, the drone may comprise positive and negative dihedral angles of different values.

For example, the positive dihedral angle on the upper wings is between 15° and 25°, and preferably 20°. Similarly, in the drone illustrated, the negative dihedral angle on the lower wings is between 15° and 25°, and preferably 20°.

As can be seen in FIG. 1, the lift-producing wings have a wingspan such that the lever arm between the centre of gravity of the drone and the propulsion unit allows stable flight in aircraft mode. In the example illustrated in FIG. 1, the wingspan is 30 cm.

Furthermore, the lift-producing wings have a lift surface appropriate for allowing the drone to fly in aircraft mode using the lift of the four wings. The surface of the wings is determined so as to offer good lift without having a major impact on the flight performance of the drone in conventional flight.

As shown in FIG. 1, the lift-producing wings 16 of the drone form a sweep angle β relative to the drone body 12; the sweep angle β may be between 5° and 20°, and preferably approximately 10°.

According to a particular embodiment, each of the propulsion units (apart from the propellers) of the drone is in the same plane as the wing to which it is secured. In other words, each of the propellers on the propulsion units is on a plane that is substantially perpendicular to the plane of the lift surface of the wing to which the propeller is secured.

However, according to the embodiment illustrated in FIG. 1 and in FIG. 4, the four propulsion units form an angle of inclination relative to the horizontal median plane of the drone body, the two propulsion units positioned on one side of the drone body each being inclined towards one another at a predetermined positive vertical angle of inclination and a predetermined negative vertical angle of inclination. Symmetrically, the two propulsion units positioned on the other side of the drone body are each inclined towards one another at the same predetermined positive vertical angle of inclination and the same predetermined negative vertical angle of inclination.

In other words, the propulsion units situated on either side of the drone body above the horizontal median plane of the drone body, when the drone is in the aircraft flight position, are each inclined towards the propulsion units situated on the same side of the drone body below said horizontal median plane, and vice versa. The propulsion units situated on either side of the drone body below said horizontal median plane are in particular each inclined towards the propulsion units situated on the same side of the drone body above the horizontal median plane.

The inclination of the propulsion units allows, in aircraft mode, a horizontal traction component to be created that is perpendicular to the direction of forward movement which contributes to increasing the available torque on the heading axis of the drone, which otherwise would result only from the torque of the propellers on the drone. This increase in torque may have an advantage for flight in aircraft mode, i.e. using the lift of the wings of the drone. This is because the increase in torque allows the displacement inertia of the drone to be counterbalanced on the heading axis in aircraft mode, which inertia is much greater than on a conventional drone, i.e. with no lift-producing wings, owing to the presence of lift-producing wings.

The inclination of the motors leads to a reduction in the lift that is generated, as only a portion of the traction produced by the motors is applied on the horizontal plane. However, as this type of inclination creates a horizontal traction component, this contributes to increasing control of the drone on the heading axis in aircraft mode, as the application of a horizontal force on the lever arm that exists between the motors and the centre of gravity of the drone, optimised by placing propulsion units substantially at the ends of the wings, allows torque to be created on the heading axis which will be added to the torque of the propellers.

The traction needed for the drone to be able to fly in aircraft mode, i.e. using the lift of the wings, is less than the traction needed to allow the drone to maintain a fixed point in its conventional flight configuration, i.e. stationary flight.

It should also be noted that the Z axis of the drone, which corresponds to the heading axis when the drone is flying in conventional mode, i.e. using the rotary wing, becomes the roll axis when the drone is flying in aircraft mode, i.e. substantially horizontally using the lift of the wings.

According to a particular embodiment, the predetermined angles of inclination of the four propulsion units are identical as an absolute value.

However, according to another embodiment, the propulsion units situated above the horizontal median plane of the drone body, when the drone is in aircraft flight position, may have an angle of inclination as an absolute value that is different from the angles of inclination of the propulsion units situated below said horizontal median plane.

According to a particular embodiment, the predetermined angles of inclination are between 10° and 30°, and preferably approximately 20°.

It has been noted that the consequence of an angle of inclination of 20° as an absolute value applied to the propulsion units is losses of traction of approximately 6%. Moreover, the consequence of the circulation of the airflow around the wings when the motors rotate is an increase in the losses of traction owing to the inclination of the propulsion units. Thus, according to this embodiment, the losses of traction are approximately 24%.

According to a particular embodiment, the propulsion units may be substantially inclined so as to converge on the principal median axis of the drone and may therefore have an angle of inclination value relative to the vertical median plane of the drone body when the drone is in the aircraft flight position.

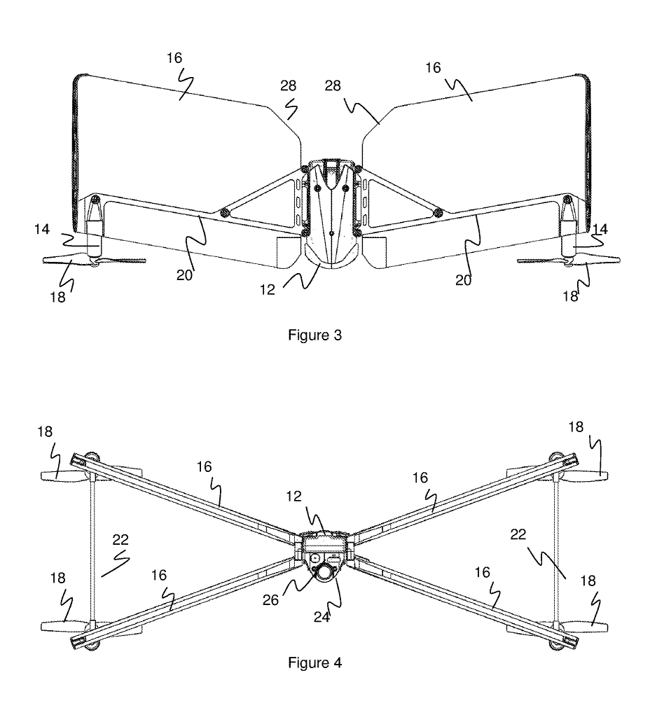

The drone illustrated in FIGS. 1, 2 and 3 comprises four lift-producing wings secured to the drone body, each wing having the shape of a parallelogram. However, other wing forms may be envisaged.

The lift-producing wings 16 may be connected to each other in pairs by at least one reinforcement means 22.

According to a particular embodiment, the lift-producing wings situated on the same side of the vertical median plane of the drone body, when the drone is in the aircraft flight position, are connected to each other by at least one reinforcement means 22 secured for example substantially close to the propulsion units. FIG. 1 shows an embodiment in which a single reinforcement means is secured between the lift-producing wings on the same side of the drone.

According to a particular embodiment of the drone, the wings may be provided with ailerons allowing the rotations of the drone to be controlled during flight in aircraft mode.

According to another particular embodiment, the drone may have no wing control surfaces such as aileron-type control surfaces. The movement of the drone in aircraft flight mode will in this case be controlled by controlling the rotational speed of the different propulsion units.

The drone is also equipped with inertial sensors (accelerometers or gyrometers) for measuring, to a particular degree of precision, the angular velocities and attitude angles of the drone, i.e. the Euler angles (pitch, roll and yaw) describing the inclination of the drone relative to a horizontal plane of a point of reference on the ground that is established before take-off, when the drone is switched on in accordance with the usual NED (north, east, down) convention, with the understanding that the two longitudinal and transverse components of the horizontal velocity are closely linked to the inclination along the two pitch and roll axes, respectively.

The drone 10 is controlled by a remote piloting device such as a multimedia telephone or tablet having a touch screen and integrated accelerometers, for example an iPhone-type (registered trade mark) or other mobile telephone, or an iPad-type (registered trade mark) or other tablet. This is a standard apparatus that has not been modified except for the downloading of a custom software application in order to control the piloting of the drone 10. According to this embodiment, the user controls the movement of the drone 10 in real time using the piloting device.

The piloting control device is an apparatus provided with a touch screen displaying a number of symbols allowing commands to be activated simply by a user touching the touch screen with their finger.

The piloting device communicates with the drone 10 via a bidirectional data exchange by means of a wireless local network such as Wi-Fi (IEEE 802.11) or Bluetooth (registered trade marks), namely from the drone 10 to the piloting device, in particular for transmitting flight data, and from the control device to the drone 10 for sending piloting commands.

The piloting device is also provided with inclination sensors allowing the attitude of the drone to be controlled by sending commands depending on the roll, yaw and pitch axes in the reference point of the drone (see WO 2010/061099 A2 for further details on these aspects of the system).

Whatever the flight mode of the drone, the piloting device has the same navigation symbols on the touch screen; however, the navigation commands issued to the drone will be analysed with regard to the real reference point of the drone.

Thus, the user controls the drone directly, for example, by a combination of:

commands available on the touch screen, notably ‘ascent/descent’ and

signals emitted by the inclination detector of the apparatus: for example, to move the drone forwards the user tilts their apparatus along the corresponding pitch axis, and to turn the drone to the left or to the right they tilt said apparatus relative to the roll axis.

In order to allow the piloting commands to be implemented by the drone, in particular, to dynamically control the attitude of the drone when the drone is flying using the lift of the wings according to the invention, a control method according to the invention is implemented, which will now be described.

When the drone is flying using the lift of the wings, the drone flies at a given pitch angle during the conversion operation.

According to the invention, the attitude of the drone is controlled by sending differentiated commands to one or more of said propulsion units 14 so as to rotate the drone about the roll axis and/or the pitch axis and/or the heading axis of the drone from a current angular position to a final angular position, said axes being defined in a reference point of the drone.

Thus, according to the invention, the attitude of the drone can be controlled without the drone having a wing control surface. In other words, the attitude of the drone can be controlled simply by sending said commands to one or more of said propulsion units. By activating piloting commands on the remote piloting device, the user will therefore allow the attitude of the drone to be modified when the drone is flying using the lift of the wings, the piloting commands bringing about a change in the rotational speed of the propulsion units.

To do this, the piloting commands are issued to the drone so as to then determine the commands to be sent to the different propulsion units in order to rotate the drone about the roll axis, and/or pitch axis and/or heading axis of the drone depending on the command from the user.

With a view to modifying the attitude of the drone according to the invention, a command comprising an angular velocity about a yaw axis ψᵤₛᵣ is issued from the piloting device to the drone.

In order to produce a coordinated turn of the drone, according to an embodiment of the invention, the integrated navigation and attitude control system of the drone will generate a set value for rotation about the roll axis, on the basis of the angular velocity about a yaw axis ψᵤₛᵣ, controlled by the user, the angle of incidence α of the drone corresponding to the angle of inclination of the drone along the pitch axis relative to the horizontal and the aerodynamic speed V of the displacement of the drone depending on the inclination thereof, i.e. the horizontal speed of movement of the drone relative to the pitch axis.

Then, on the basis of the rotational speed controlled by the user ψᵤₛᵣ and on the basis of the set value for rotation about the roll axis that has been generated, the integrated navigation and attitude control system of the drone will determine, on the basis of a model of the dynamics of the drone:

a trajectory in terms of angular velocity and/or angular acceleration and/or angle, corresponding to the set value given by the user and used as a reference by the integrated navigation and attitude control system of the drone, and

an anticipatory pre-command in order to execute said trajectory in an open loop, said pre-command being transmitted to the integrated navigation and attitude control system of the drone in order to anticipate the trajectory to be taken. Said anticipatory pre-command allows the moving drone to be oriented on the trajectory desired by the user, the integrated navigation and attitude control system of the drone neutralising disturbances relative to the trajectory.

On the basis of the determined angular trajectory, the anticipatory pre-command and the measurements coming from the inertial unit of the drone, the integrated navigation and attitude control system of the drone will generate one or more differentiated commands and will transmit said commands to one or more of the propulsion units of the drone so as to rotate the drone.

The different steps of the method implemented in the drone in order to dynamically control the attitude of the drone and in particular to determine the differentiated commands to be sent to one or more propulsion units of the drone will now be described.

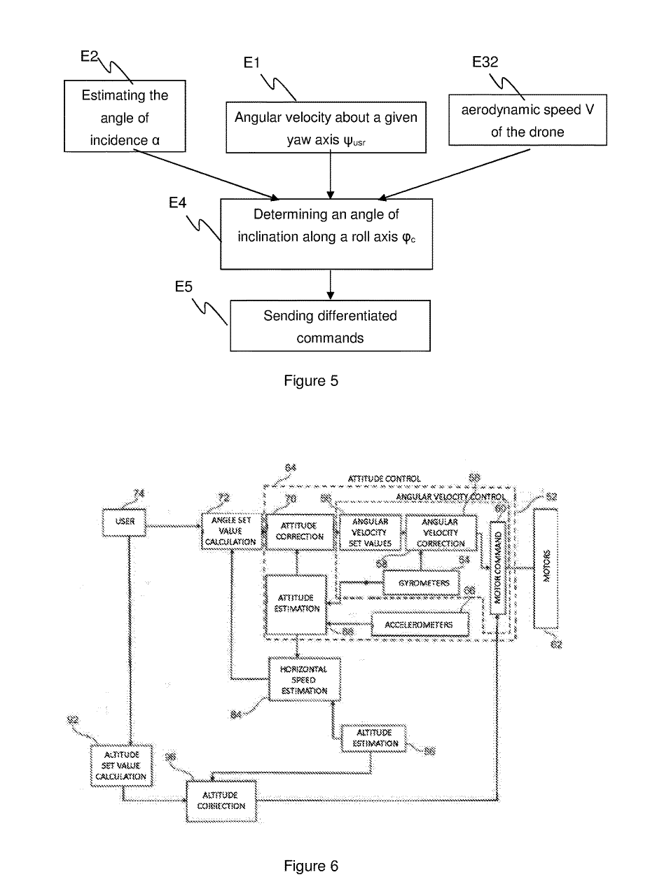

The method for dynamic control is illustrated in FIG. 5.

The method comprises a step E1 of receiving a rotation command for the drone, the command comprising an angular velocity about a yaw axis ψᵤₛᵣ.

The method comprises a step E2 consisting of a step of estimating an angle of incidence α of the drone body relative to the horizontal. In other words, the angle of incidence α corresponds to the angle of rotation of the drone relative to the horizontal of a point of reference on the ground that is established before take-off when the drone is switched on in accordance with the usual NED convention. The angle of incidence α, i.e. the pitch angle of the drone when it switches to aircraft mode, is determined for example according to the pitch angle θ of said drone body. In particular, the angle of incidence α may be determined such that:

α=|θ|−90° i)

θ being defined as the nose-up angle of the drone, in other words the pitch angle of the drone in the drone reference point.

The angle of incidence α is estimated for example from the measurements of the inertial sensors of the drone, in particular the accelerometers and/or the gyrometers with which the drone is equipped, and which are suitable for measuring, to a particular degree of precision, the attitude angles of the drone, i.e. the Euler angles (pitch □, roll □ and yaw □) describing the inclination of the drone relative to a horizontal plane of a point of reference on the ground that is established before take-off of when the drone is switched on in accordance with the usual NED convention.

The method comprises a step E3 of calculating the aerodynamic speed V of the displacement of the drone. The aerodynamic speed may be an estimate of the horizontal speed of the drone relative to the air, obtained on the basis of a model.

Steps E1, E2 and E3 may be executed sequentially, but preferably, said steps are carried out in parallel at least with regard to steps E2 and E3.

The method continues with a step E4 of determining an angle of inclination along a roll axis φ_{c} according to the estimated angle of incidence α, the aerodynamic speed V and the given angular velocity about a yaw axis ψᵤₛᵣ.

The angle of inclination may be defined such that:

$${ϕ}_{c} = {tan}^{- 1} \frac{cos α V {ψ}_{usr}}{g}$$

g being the gravitational acceleration.

Step E4 is followed by step E5 of sending one or more differentiated commands determined according to the determined angle of inclination φ_{c} to one or more of said propulsion units of the drone in order to control the attitude of said drone.

Step E5 of sending one or more differentiated commands comprises for example generating roll angle set values and applying said set values to a servo-control loop of the motors of the drone.

The steps of the method are carried out periodically until said final angular position, i.e. the flight position desired by the user, is achieved. In other words, the steps of the method are repeated for as long as the current angular position of the drone has not achieved the final angular position desired by the user.

The method also comprises:

a step of estimating the aerodynamic speed V of the drone on the basis of a model and

a step of measuring the altitude of the drone, and

a step of sending differentiated commands for the motors so as to maintain the altitude of the drone, said step comprising a closed-loop control phase of the motors.

In order to determine the aerodynamic speed of the drone, it is necessary to first determine the lift coefficient of the wings, in particular from the geometry thereof. According to a particular embodiment, thin airfoil theory is used. Said theory is principally valid when the drone flies with a pitch angle of almost 90°. Said theory allows a velocity curve to be obtained for the different pitch angle values of the drone. The velocity values are slightly underestimated but still allow good evaluation of the lift coefficient of the wings. The lift coefficient C_{L} is defined as follows:

$${C}_{L} = + 2 π α \frac{Λ}{Λ + 2} , avec Λ = \frac{{b}^{2}}{S}$$

with b being the wingspan of the wing, S the surface of the wing and a the angle of incidence.

It should be noted that C_{L} is the lift coefficient at zero incidence, which has a value of 0 if the wing profile is symmetric.

The aerodynamic speed V of the drone is determined on the basis of the determined lift coefficient C_{L} that is necessary to counterbalance the weight of the drone for each inclination at the pitch angle of the drone. To do this, the lift force L is determined according to the following formula:

L=½ρSV²C_{L}

ρ being the density of the air.

The aerodynamic speed V of the drone deduced therefrom is:

$$V = \sqrt{\frac{2 L}{ρ S {C}_{L}}}$$

The sending of one or more differentiated commands is carried out after roll angle set values corresponding to the angle of inclination to be implemented have been generated and after said set values have been applied to a servo-control loop of the motors of the drone.

The angle set value is determined in the form of an ideal angular trajectory which the drone should follow and will be used as the set value by the integrated navigation and attitude control system of the drone. The command allowing said trajectory to be executed as an open loop comprises an anticipatory pre-command which completes the integrated navigation and attitude control system command, said command being determined on the basis of a servo-control loop taking into consideration the difference between the ideal trajectory that the drone should follow in accordance with the set value received and the trajectory said drone actually takes.

According to an embodiment of the invention, when the command received by the drone is a command containing an angular velocity about the pitch axis, the drone flying in aircraft mode at a given pitch angle, then the consequence of said command will be to increase and decrease the horizontal flight speed of the drone.

Said acceleration/deceleration command will lead to a change in the equilibrium of the drone, along the pitch axis thereof, in particular by increasing or reducing the rotational speed of the motors.

However, the impact of such a change in the speed of the motors is that the altitude of the drone is modified. In order to avoid such an impact, control and servo-control components controlling the altitude of the drone are provided, said components being coupled to a vertical accelerometer and/or a barometer. Control of this kind makes it possible to counterbalance any potential errors on the drone that could lead to undesirable effects on the altitude.

This type of altitude control is even more important if the flight pitch angle of the drone is small. Indeed, if the pitch angle is such that the wings are almost horizontal to the direction of flight, acceleration and deceleration of the speed of the motors no longer allows the altitude of the drone to be adjusted, but rather the horizontal speed of movement of the drone.

According to an embodiment of the invention, when the command received is a command to change the altitude of the drone, i.e. a command for the drone to ascend or descend in aircraft flight mode, the control method will increase the rotational speed of the propulsion units and increase the nose-up attitude of the drone, i.e. reduce the pitch angle of the drone during an ascent command of the drone, and will maintain the pitch inclination of the drone and reduce the speed of the propulsion units during a descent command of the drone.

FIG. 6 is a functional block diagram of the different control and servo-control components of the drone. It should be noted however that, although said diagram is presented in the form of interconnected circuits, implementation of the different functions is essentially computer-based, and said diagram is simply illustrative.

The method for dynamically controlling the attitude of a rotary-wing drone according to the invention brings into play a plurality of overlapping loops to control the angular velocity and attitude of the drone, and also to control the variations in altitude either automatically or in response to a user command.

The most central loop, which is the angular velocity control loop 52, uses on the one hand the signals supplied by the gyrometers 54, and on the other hand a reference made up of the angular velocity set values 56, these different items of information being applied as input to a stage 58 of correcting the angular velocity. Said stage 58 controls a stage 60 which controls the motors 62 in order to separately control the speed of the different motors so as to control the angular velocity of the drone by the combined action of the rotors driven by said motors.

The angular velocity control loop 52 overlaps with an attitude control loop 64, which operates on the basis of information supplied by the gyrometers 54 and the accelerometers 66, said data being applied as input to an attitude estimation stage 68, the output of which is applied to a PI (proportional-integral) attitude correction stage 70. Stage 70 delivers angular velocity set values to stage 56, which values are also a function of the angle set values generated by a circuit 72 from commands applied directly by the user 74, said angle set values being generated in accordance with the method for dynamically controlling the attitude of the drone according to the invention.

On the basis of the error between the set value and the measurement of the angle given by the attitude estimation circuit 68, the attitude control loop 64 (circuits 54 to 70) calculates an angular velocity set value with the aid of the PI corrector of the circuit 70. The angular velocity control loop 52 (circuits 54 to 60) then calculates the difference between the preceding angular velocity set value and the angular velocity actually measured by the gyrometers 54. On the basis of this information, the loop calculates the different rotational speed set values to be sent to the motors 62 of the drone in order to produce the rotation requested by the user.

The horizontal velocity V is estimated by the circuit 84 on the basis of the information supplied by the attitude estimation circuit 68 and the altitude estimation given by the circuit 86, and also a model. The estimation of the horizontal velocity V carried out by the circuit 84 is supplied to the circuit 72 for implementing the method for dynamically controlling the attitude of the drone according to the invention.

With regard to the altitude movements of the drone in aircraft flight, the user 74 applies an altitude set value to a circuit 92 which, on the basis of the circuit 96, calculates an altitude set value from the altitude estimation given by the circuit 86.

We claim:

1. A method for dynamically controlling the attitude of a rotary-wing drone, the method comprising:
when the drone is flying using lift of each of four wings of the drone, controlling the attitude of the drone by sending differentiated commands to one or more propulsion units of the drone so as to rotate the drone about a roll axis and/or pitch axis and/or heading axis of the drone from a current angular position to a final angular position, said axes being defined in the reference point of the drone.

2. The method for dynamic control according to claim 1, wherein the attitude of the drone is controlled solely by sending said commands to one or more of said propulsion units.

3. The method for dynamic control according to claim 1, wherein the method further comprises:
estimating an angle of incidence α of a drone body of the drone relative to the horizontal,
calculating the aerodynamic speed V of the displacement of the drone,
determining an angle of inclination along a roll axis φ_{c} according to the estimated angle of incidence α, the aerodynamic speed V and a given angular velocity about a yaw axis ψᵤₛᵣ, and
sending one or more differentiated commands determined according to the determined angle of inclination φ_{c} to one or more of said propulsion units in order to control the attitude of said drone.

4. The method for dynamic control according to claim 3, wherein the step of sending one or more differentiated commands comprises generating roll angle set values and applying said set values to a servo-control loop of the motors of the drone.

5. The method for dynamic control according to claim 3, wherein the steps of the method are carried out periodically until said final angular position is achieved.

6. The method for dynamic control according to claim 3, wherein the angle of incidence α is determined according to the pitch angle θ of said drone body.

7. The method for dynamic control according to claim 6, wherein the angle of incidence α is determined such that:
α=|θ|−90°

8. The method for dynamic control according to claim 7, wherein the angle of inclination is such that:
$${ϕ}_{c} = {tan}^{- 1} \frac{cos α V {ψ}_{usr}}{g}$$
g being the gravitational acceleration.

9. The method for dynamic control according to claim 1, wherein the method also comprises:
estimating the aerodynamic speed V of the displacement of the drone on the basis of a model,
measuring the altitude of the drone, and,
sending differentiated commands for the motors in order to maintain the altitude of the drone, said step comprising a closed-loop control phase of the motors.

10. The method for dynamic control according to claim 1, wherein the horizontal speed of the drone is controlled by modifying the pitch angle.

11. A rotary-wing drone comprising
a drone body that comprises an electronic board which controls the piloting of the drone,
four link arms, each arm comprising a rigidly connected propulsion unit,
wherein the four link arms form lift-producing wings,
wherein the electronic board has computer programming enabled to dynamically control the attitude of said drone when the drone is flying using lift of each of four wings of the drone, by controlling the attitude of the drone by sending differentiated commands to one or more propulsion units of the drone so as to rotate the drone about a roll axis and/or pitch axis and/or heading axis of the drone from a current angular position to a final angular position, said axes being defined in the reference point of the drone.
